(19) United States
(12) Patent Application Publication
(10) Pub. No.: US 2017/0242849 A1
(43) Pub. Date: Aug. 24, 2017

(54) METHODS AND SYSTEMS FOR EXTRACTING CONTENT ITEMS FROM CONTENT

(71) Applicant: YEN4KEN, INC., Princeton, NJ (US)

(72) Inventors: Arijit Biswas, Kolkata (IN); Ankit Gandhi, Raipur (C.G.) (IN); Om D Deshmukh, Bangalore (IN)

(21) Appl. No.: 15/051,718

(22) Filed: Feb. 24, 2016

(51) Int. Cl. G06F 17/30

(52) U.S. Cl. CPC G06F 17/3002

(57) ABSTRACT

According to embodiments illustrated herein, a method and a system is provided for extracting one or more content items from content. The method includes determining, by one or more processors, one or more features associated with each of a plurality of content items in the content. Further, determining, by the one or more processors, a score for each of the plurality of content items based on a weight assigned to each of the one or more features associated with each of the plurality of content items. Thereafter, one or more content items are extracted from the plurality of content items based on the determined score to create at least an index of the content.

### TECHNICAL FIELD

The presently disclosed embodiments are related, in general, to content processing. More particularly, the presently disclosed embodiments are related to methods and systems for extracting one or more content items from the content.

### BACKGROUND

Advancements in the field of education have led to the usage of Massive Open Online Courses (MOCCs) as one of the popular modes of learning. Educational organizations provide content in the form of video lectures, reading content, and/or audio lectures to students for learning.

Usually the content such as educational multimedia content is of long duration. Reading and understanding such content is time consuming. For example, it may be difficult for a student to read/understand multimedia content within a stipulated period. Therefore, it may be necessary to summarize the content to generate a shortened/summarized version of the content to help the user/student to read/understand the context of the content. In certain scenarios, to summarize the multimedia content, it may be required to extract one or more content items from the content.

Further limitations and disadvantages of conventional and traditional approaches will become apparent to those skilled in the art, through a comparison of described systems with some aspects of the present disclosure, as set forth in the remainder of the present application and with reference to the drawings.

### SUMMARY

According to embodiments illustrated herein, there is provided a method for extracting one or more content items from content. The method includes determining, by one or more processors, one or more features associated with each of a plurality of content items in said content, wherein the one or more features comprises at least a frequency of occurrence of said plurality of content items in said content, a position of said plurality of content items in said content, and a formatting associated with said plurality of content items, wherein said formatting comprises one or more of: a font size, bolding of said plurality of content items, an underlining of said plurality of content items, a letter case associated with said plurality of content items. The method further includes determining, by said one or more processors, a predetermined weight for each of said one or more features by one or more classifiers, wherein the one or more classifiers are trained based on one or more inputs, pertaining to selection of one or more content items from another content, received from one or more worker computing devices. The method further includes determining, by said one or more processors, a score for each of said plurality of content items based on the predetermined weight of each of said one or more features associated with each of said plurality of content items. The method furthermore includes extracting, by said one or more processors, said one or more content items from said plurality of content items based on said determined score, wherein extracted said one or more content items are utilized to create at least an index of said content.

According to embodiments illustrated herein, there is provided a system for extracting one or more content items from content, said system comprising one or more processors configured to determine one or more features associated with each of a plurality of content items in said content, wherein the one or more features comprises at least a frequency of occurrence of said plurality of content items in said content. The one or more processors are further configured to determine a score for each of said plurality of content items based on a weight assigned to each of said one or more features associated with each of said plurality of content items, and a feature value associated with each of the one or more features. The one or more processors are further configured to extract said one or more content items from said plurality of content items based on said determined score, wherein extracted said one or more content items are utilized to create at least an index of said content.

According to embodiments illustrated herein, there is provided a non-transitory computer readable medium having stored thereon, a computer program having at least one code section executable by a computer, thereby causing the computer to perform steps comprising determining one or more features associated with each of a plurality of content items in content, wherein the one or more features comprises at least a frequency of occurrence of said plurality of content items in said content. The steps further comprises determining a score for each of said plurality of content items based on a predetermined weight assigned to each of said one or more features associated with each of said plurality of content items. Said one or more content items are extracted from said plurality of content items based on said determined score, wherein extracted said one or more content items are utilized to create at least an index of said content.

### BRIEF DESCRIPTION OF DRAWINGS

The accompanying drawings illustrate the various embodiments of systems, methods, and other aspects of the disclosure. Any person with ordinary skills in the art will appreciate that the illustrated element boundaries (e.g., boxes, groups of boxes, or other shapes) in the figures represent one example of the boundaries. In some examples, one element may be designed as multiple elements, or multiple elements may be designed as one element. In some examples, an element shown as an internal component of one element may be implemented as an external component in another, and vice versa. Further, the elements may not be drawn to scale.

Various embodiments will hereinafter be described in accordance with the appended drawings, which are provided to illustrate and not to limit the scope in any manner, wherein similar designations denote similar elements, and in which:

FIG. 1 is a block diagram illustrating a system environment in which various embodiments may be implemented;

FIG. 2 is a block diagram that illustrates an application server configured for extracting content items from content, in accordance with at least one embodiment;

FIG. 3 illustrates a flowchart of a method for extracting content items from content, in accordance with at least one embodiment;

FIGS. 4A and 4B illustrate an image frame extracted from content, in accordance with at least one embodiment;

### DETAILED DESCRIPTION

The present disclosure is best understood with reference to the detailed figures and description set forth herein. Various embodiments are discussed below with reference to the figures. However, those skilled in the art will readily appreciate that the detailed descriptions given herein with respect to the figures are simply for explanatory purposes as the methods and systems may extend beyond the described embodiments. For example, the teachings presented and the needs of a particular application may yield multiple alternative and suitable approaches to implement the functionality of any detail described herein. Therefore, any approach may extend beyond the particular implementation choices in the following embodiments described and shown.

References to “one embodiment,” “at least one embodiment,” “an embodiment,” “one example,” “an example,” “for example,” and so on indicate that the embodiment(s) or example(s) may include a particular feature, structure, characteristic, property, element, or limitation but that not every embodiment or example necessarily includes that particular feature, structure, characteristic, property, element, or limitation. Further, repeated use of the phrase “in an embodiment” does not necessarily refer to the same embodiment.

Definitions: The following terms shall have, for the purposes of this application, the respective meanings set forth below.

“Content” refers to at least one of, but is not limited to, a video content, a text content, an image content, or an animation content. In an embodiment, the content may be reproduced through an application such as a media player (e.g., VLC Media Player, Windows Media Player, Windows Photo Viewer, Adobe Flash Player, Microsoft Office Power Point, Apple QuickTime Player, etc.) on a computing device. In an embodiment, the content may be downloaded or streamed from a server to the computing device. In an alternate embodiment, the content may be stored on a media storage device such as Hard Disk Drive, CD Drive, Pen Drive, etc., connected to (or inbuilt within) the computing device.

“Content item” refers to a perceivable object in the content. In an embodiment, the content item may correspond to a text content that may comprise a plurality of keywords, or image content. In an embodiment, the image content may further correspond to a human object in the content. For example, a presenter in a multimedia content may correspond to the image content.

A “frame” may refer to an image that corresponds to a single picture or a still shot that is a part of a larger multimedia content (e.g., a video). A multimedia content is usually comprises a plurality of frames that are rendered, on a display device, in succession to produce what appears to be a seamless piece of the multimedia content. In an embodiment, the frame in the multimedia content may include a plurality of content items. In an embodiment, the content item may correspond to a text content. The text content may include a plurality of keywords that are arranged in the form of sentences. The sentences may have a meaningful interpretation. In an embodiment, the text content may be represented/presented/displayed in a predetermined area of the frame. In an embodiment, the predetermined area where the text content is displayed in the plurality of frames corresponds to at least one of a blackboard, a whiteboard, a paper, and/or a projection screen.

A “feature” refers to characteristic associated with a plurality of content items in a content. The feature may correspond to a visual feature associated with the plurality of content items in the content. The visual feature may include, but is not limited to, a position of a content item in the content, a frequency of occurrences of the content item in the content. In an embodiment, the feature may further correspond to one or more aesthetic features associated with the plurality of content items. In an embodiment, the one or more aesthetic features may include, but are not limited to, bolding, font size, font type, letter case, underlining, and color of the content item.

A “position” of a content item may refer to coordinates of the content item in the content. For instance, if the content corresponds to multimedia content that comprises a plurality of frames, then the position of the content item may correspond to the coordinates of the content item in a frame of the plurality of frames.

A “weight” may refer to a measure of importance of a feature associated with plurality of content items in the content. In an embodiment, the weight associated with the feature may be determined based on crowdsourcing.

A “first intermediate score” may refer to a score associated with a content item that may vary based on a relative position of the content item from a center position of a frame of a content. In an embodiment, a distribution of the first intermediate score may be represented as a Gaussian function along a width of the frame.

A “second intermediate score” may refer to a score associated with a content item that may vary based on a relative position of a content item from a top most edge of a frame of a content. In an embodiment, a distribution of the second intermediate score may be represented as a Gaussian function along a length of the frame.

“One or more classifiers” may refer to a mathematical model that may be configured to assign weights to one or more features associated with a content items in a multimedia content. In an embodiment, the one or more classifiers are trained based on training data. Examples of the one or more techniques that may be utilized to train a classifier include, but are not limited to, a Support Vector Machine (SVM), a Logistic Regression, a Bayesian Classifier, a Decision Tree Classifier, a Copula-based Classifier, a K-Nearest Neighbors (KNN) Classifier, or a Random Forest (RF) Classifier.

“Extraction” of one or more content items may be referred to as identification of one or more content items in a multimedia content that are replicated across multiple instances in the multimedia content. In an embodiment, the one or more content items may correspond to a linguistic and/or a contextual meaning of the multimedia content. In an embodiment, the extracted one or more content items may be utilized to index the multimedia content in a content repository server, create a table of contents for the multimedia content, and/or summarize the multimedia content.

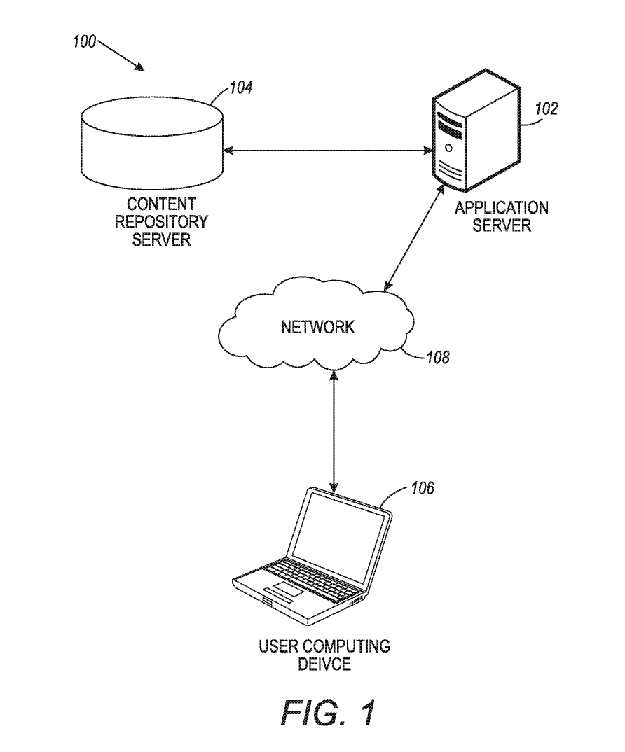

FIG. 1 is a block diagram of a system environment 100, in which various embodiments can be implemented. The system environment 100 includes an application server 102, a content repository server 104, a user-computing device 106, and a network 108.

In an embodiment, the application server 102 refers to a computing device or a software framework hosting an application or a software service. In an embodiment, the application server 102 may be implemented to execute procedures such as, but not limited to, programs, routines, or scripts stored in one or more memories for supporting the hosted application or the software service. In an embodiment, the hosted application or the software service may be configured to perform one or more predetermined operations. In an embodiment, the application server 102 may be configured to transmit a query to the content repository server 104 to retrieve content. In an embodiment, the application server 102 may be configured to stream the content on the user-computing device 106 over the network 108. In an alternate embodiment, the application server 102 may be configured to play/render the content on a display device associated with the application server 102 through an application software such as a VLC Media Player, a Windows Media Player, an Adobe Flash Player, an Apple QuickTime Player, and the like. In such a scenario, the user-computing device 106 may access or control the display of the content through a remote connection using one or more protocols such as remote desktop connection protocol, and PCoIP.

In an embodiment, the application server 102 may be configured to extract a plurality of content items from the content. Thereafter, the application server 102 may determine one or more features associated with each of the plurality of content items by utilizing one or more image processing techniques and/or text processing techniques. In an embodiment, the one or more features may comprise, but are not limited to, a frequency of occurrences of the plurality of content items in the content, a position of the plurality of content items in the content, and one or more aesthetic features associated with the plurality of content items. In an embodiment, the one or more aesthetic features may be indicative of look and feel of the plurality of content items in the content. For example, formatting associated with the plurality of content items may correspond to the one or more aesthetic features. In an embodiment, the formatting associated with the plurality of content items may include, but is not limited to, a font size, a bolding of the plurality of content items, an underlining of the plurality of content items, a color associated with the plurality of content items, and a letter case. Further, the application server 102 may determine a score for each of the plurality of content items based on a predetermined weight assigned to each of the one or more features and feature values of the one or more features. In an embodiment, the application server 102 may extract one or more content items from the plurality of content items based on the determined score.

The application server 102 may be realized through various types of application servers such as, but not limited to, a Java application server, a .NET framework application server, a Base4 application server, a PHP framework application server, or any other application server framework.

In an embodiment, the content repository server 104 may be configured to store the content. In an embodiment, the content repository server 104 may receive the query from the application server 102 to retrieve the content. In an embodiment, the content repository server 104 may be realized as a database server through various technologies such as, but not limited to, Microsoft® SQL Server, Oracle®, IBM DB2®, Microsoft Access®, PostgreSQL®, MySQL® and SQLite®. In an embodiment, the application server 102 may connect to the content repository server 104 using one or more protocols such as, but not limited to, Open Database Connectivity (ODBC) protocol and Java Database Connectivity (JDBC) protocol.

A person with ordinary skills in the art will understand that the scope of the disclosure is not limited to the content repository server 104 as a separate entity. In an embodiment, the functionalities of the content repository server 104 can be integrated into the application server 102.

In an embodiment, the user-computing device 106 may refer to a computing device used by a user. The user-computing device 106 may comprise one or more processors and one or more memories. The one or more memories may include a computer readable code that may be executable by the one or more processors to perform predetermined operations. In an embodiment, the user-computing device 106 may present the user-interface, received from the application server 102, to the user to display/playback/render the content. In an embodiment, the user-computing device 106 may include hardware and/or software to display the content. Examples of the user-computing device 106 may include, but are not limited to, a personal computer, a laptop, a personal digital assistant (PDA), a mobile device, a tablet, or any other computing device.

A person having ordinary skill in the art will appreciate that the scope of the disclosure is not limited to realizing the application server 102 and the user-computing device 106 as separate entities. In an embodiment, the application server 102 may be realized as an application program installed on and/or running on the user-computing device 106 without departing from the scope of the disclosure.

In an embodiment, the network 108 may correspond to a communication medium through which the application server 102, the content repository server 104, and the user-computing device 106 may communicate with each other. Such a communication may be performed in accordance with various wired and wireless communication protocols. Examples of such wired and wireless communication protocols include, but are not limited to, Transmission Control Protocol and Internet Protocol (TCP/IP), User Datagram Protocol (UDP), Hypertext Transfer Protocol (HTTP), File Transfer Protocol (FTP), ZigBee, EDGE, infrared (IR), IEEE 802.11, 802.16, 2G, 3G, 4G cellular communication protocols, and/or Bluetooth (BT) communication protocols. The network 108 may include, but is not limited to, the Internet, a cloud network, a Wireless Fidelity (Wi-Fi) network, a Wireless Local Area Network (WLAN), a Local Area Network (LAN), a telephone line (POTS), and/or a Metropolitan Area Network (MAN).

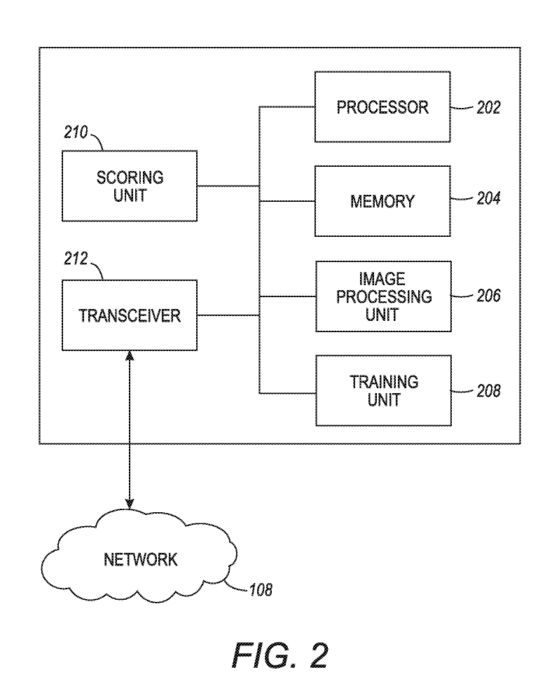

FIG. 2 is a block diagram that illustrates the application server 102 configured for extracting the one or more content items from the content, in accordance with at least one embodiment. In an embodiment, the application server 102 includes a processor 202, a memory 204, an image processing unit 206, a training unit 208, a scoring unit 210, and a transceiver 212. The processor 202 is coupled to the memory 204, the image processing unit 206, the training unit 208, the scoring unit 210, and the transceiver 212.

The processor 202 includes suitable logic, circuitry, and/or interfaces that are operable to execute one or more instructions stored in the memory 204 to perform predetermined operations. The processor 202 may be implemented using one or more processor technologies known in the art. Examples of the processor 202 include, but are not limited to, an x86 processor, an ARM processor, a Reduced Instruction Set Computing (RISC) processor, an Application Specific Integrated Circuit (ASIC) processor, a Complex Instruction Set Computing (CISC) processor, or any other processor.

The memory 204 stores a set of instructions and data. Some of the commonly known memory implementations include, but are not limited to, a random access memory (RAM), a read only memory (ROM), a hard disk drive (HDD), and a secure digital (SD) card. Further, the memory 204 includes one or more instructions that are executable by the processor 202 to perform specific operations. It is apparent to a person with ordinary skills in the art that the one or more instructions stored in the memory 204 enable the hardware of the application server 102 to perform the predetermined operations.

The image processing unit 206 may be configured to perform one or more image processing/analysis operations on the content. In an embodiment, the image processing unit 206 may include one or more electronic circuits and/or gates configured to perform one or more predefined image processing operations. Examples of the one or more predefined image processing operations may include, but are not limited to, an image transformation (e.g., conversion of an image from a spatial domain to a frequency domain and vice versa), a content item detection in the content, a color detection of the content item, edge/contour/ridge detection, optical character recognition, an image noise reduction, an image thresholding, and an image enhancement. In an embodiment, the image processing-unit 206 may be configured to identify the plurality of content items in the content. For each of the plurality of content items, the image processing unit 206 may be configured to determine the one or more features. Further, the image processing unit 206 may be configured to determine the feature value for each of the one or more features. In an embodiment, the image processing unit 206 may be implemented as an Application-Specific Integrated Circuit (ASIC) microchip designed for a special application, such as to perform the one or more predefined image processing operations.

The training unit 208 may be configured to determine weights associated with each of the one or more features of the plurality of content items. In an embodiment, the training unit 208 may be configured to crowdsource another content to the one or more worker computing devices associated with one or more workers. In an embodiment, the workers may be asked to identify appealing/relevant content items from the plurality of content items in said another content. Further, the one or more workers may be asked to mark a set of features of the one or more features associated with the appealing/relevant content items that were the reason behind selection of the content item as appealing/relevant. In an embodiment, based on the response received from the one or more workers, the training unit 208 may assign a weight to each of the one or more features. In an embodiment, based on the assigned weight, the training unit 208 may train one or more classifiers. The one or more classifiers may be later configured to assign weights to the one or more features associated with the content items in the multimedia content. In an embodiment, the training unit 208 may be implemented as an Application-Specific Integrated Circuit (ASIC) microchip designed for a special application, such as to assign weight to each of the one or more features.

The scoring unit 210 may be configured to determine a score for each of the plurality of content items. In an embodiment, the scoring unit 210 may be configured to determine a weighted sum of feature values of the one or more features associated with each of the plurality of content items. In an embodiment, the weighted sum may correspond to the score. The scoring unit 210 may be further configured to compare the determined score associated with each of the plurality of content items with a predetermined threshold value. Based on the comparison, the scoring unit 210 may be configured to select the one or more content items from the plurality of content items. In an embodiment, the scoring unit 210 may be implemented as an Application-Specific Integrated Circuit (ASIC) microchip designed for a special application, such as to select the one or more content items from the plurality of content items.

The transceiver 212 transmits and receives messages and data to/from various components of the system environment 100 over the network 108. For instance, the transceiver 212 may receive the content from the content repository server 104. Further the transceiver 212 may be configured to transmit a user interface to the user-computing device 106 through which the content is streamed/displayed/rendered on the user-computing device 106. Examples of the transceiver 212 may include, but are not limited to, an antenna, an Ethernet port, a USB port, or any other port configured to receive and transmit data. The transceiver 212 transmits and receives data/messages in accordance with the various communication protocols such as, TCP/IP, UDP, and 2G, 3G, or 4G communication protocols.

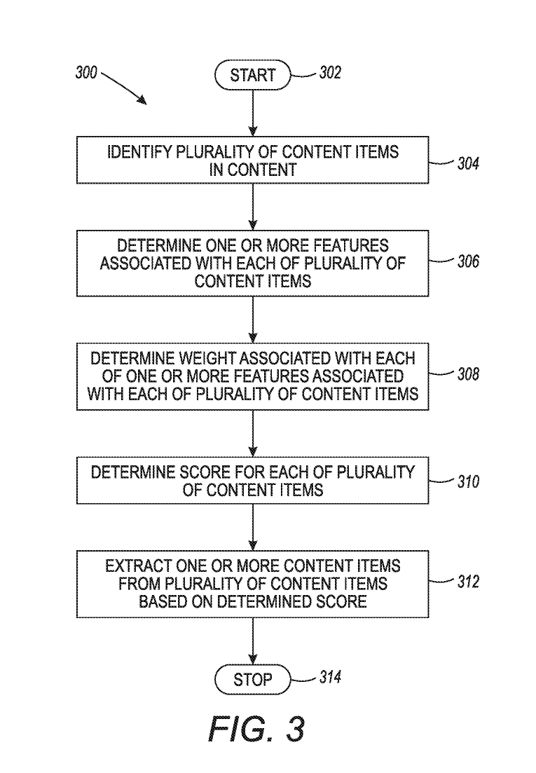

The operation of the application server 102 has been described further in conjunction with FIG. 3.

FIG. 3 illustrates a flowchart 300 of a method for identifying one or more content items in the content, in accordance with at least one embodiment. The flowchart 300 is described in conjunction with FIG. 1 and FIG. 2. The method starts at step 302.

At step 304, the plurality of content items is identified from the content. In an embodiment, the image processing unit 206, in conjunction with the processor 202, may be configured to identify the plurality of content items. In an embodiment, prior to identifying the plurality of content items, the processor 202 may transmit a query to the content repository server 104 to retrieve the content. As discussed, the content may correspond to the multimedia content or an image content or text content (e.g., a document). A person having ordinary skills in the art will understand that the multimedia content is composed of a plurality of images. Further, a person having ordinary skills in the art will understand that the text content such a document may further correspond to the text content that is rendered as an image. For example, a PDF document may correspond to an image that comprises the text content. For the purpose of ongoing description, the content is considered an image.

After retrieving the content, in an embodiment, the image processing unit 206 may determine a horizontal projection profile and a vertical projection profile of the content. In an embodiment, the projection profile may correspond to a histogram of an aggregation of pixel values that may have peaks and valleys. In an embodiment, the horizontal projection profile may correspond to a histogram with an x-axis along the width of the image (the content). In an embodiment, the pixel values for the horizontal projection profile are aggregated along the length of the image. In an embodiment, the vertical projection profile corresponds to a histogram with x-axis along the length of the image. In an embodiment, for the vertical projection profile, the pixel values are aggregated along the width of the image. A person having ordinary skills in the art will understand that the peak maybe indicative of presence of the content items in the content. Further, the valley may be indicative of empty space in the content. Based on the identification of the peaks and valleys in the horizontal projection profile and the vertical projection profile, the image processing unit 206 may be configured to identify the plurality of content items in the content. Further, for each of the identified content items, the image processing unit 206 may define a bounding box. A person having ordinary skills in the art will understand that the scope of the disclosure should not limited to the above mentioned technique to identify the one or more content items in the content. In an embodiment, the image processing unit 206 may utilize other image processing techniques such as a normalized cut based segmentation algorithm, and bounding box algorithm to identify the plurality of content items.

In an embodiment, the image processing unit 206 may recognize the plurality of content items bounded by the bounding boxes. In an embodiment, the image processing unit 206 may utilize one or more text/character recognition algorithms, optical character recognition (OCR), intelligent character recognition (ICR), and scale invariant feature transformation (SIFT) to recognize the plurality of content items. In an embodiment, when the plurality of content items corresponds to the plurality of words, the one or more text/character recognition algorithms such as optical character recognition (OCR), and intelligent character recognition (ICR) are utilized to recognize the plurality of words. Further, after recognizing the plurality of words, the image processing unit 206 may be configured to remove stop words such as prepositions, articles, adverbs, etc. Hereinafter, for the purpose of ongoing description it has been assumed that the plurality of words does not include the stop words.

At step 306, the one or more features associated with the plurality of content items are determined. In an embodiment, the image processing unit 206, in conjunction with the processor 202, may determine the one or more features associated with each of the plurality of content items. As discussed the one or more features may comprise, but are not limited to, a frequency of occurrence of a content item in the content, a position of the content item in the content, and the one or more aesthetic features associated with the content item. For the purpose of ongoing description, the plurality of content items have been considered as the plurality of words. However, the scope of the disclosure should not be construed to be limited to the plurality of content items being the plurality of words.

### Frequency of Occurrence of a Word

The image processing unit 206 may be configured to determine the number of occurrences of a word in the plurality of words, in the content. For example, if the content corresponds to a multimedia content, the image processing unit 206 may determine the number of occurrences of the word in each frame of the multimedia content. Further, if the content corresponds to a document that has one or more pages, the image processing unit 206 may determine the number of occurrences of the word in each of the one or more pages of the document.

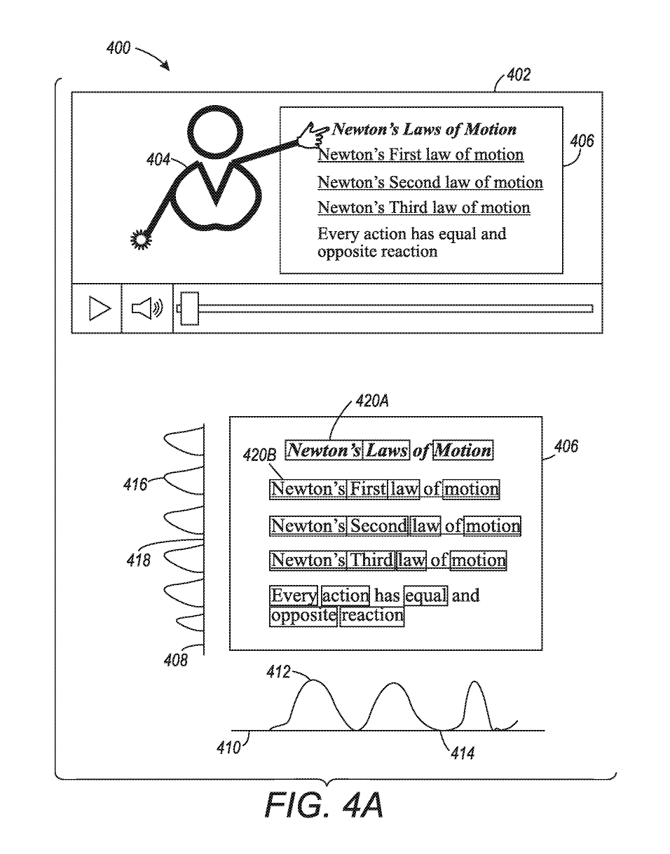

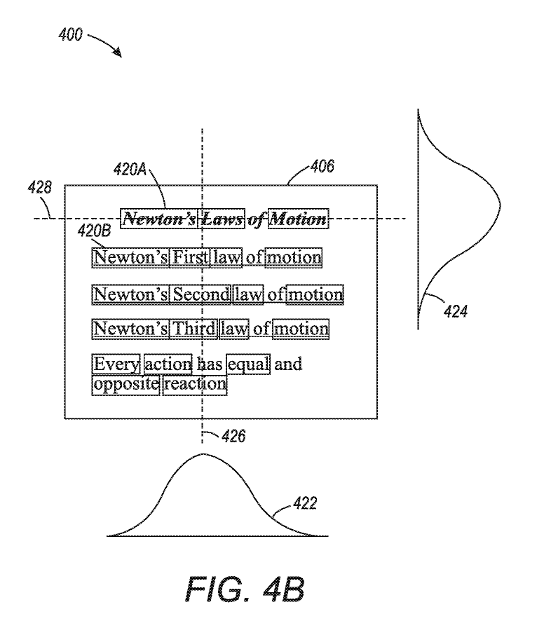

In an embodiment, a word of the plurality of words, with a higher number of occurrences in comparison with the number of occurrences of other words, may be more salient than the other words. In an embodiment, the processor 202 may normalize the number of occurrences of each of the plurality of words between zero and one. The determination of the number of occurrences of the plurality of words has been described later in conjunction with FIG. 4A.

### Position of a Word

In an embodiment, the image processing unit 206 may be configured to determine a saliency of the word of the plurality of words based on the position of the word in the content. In an embodiment, the image processing unit 206 may define a first Gaussian function and a second Gaussian function, as per the following equation:

$$f ( x , μ , σ ) = \frac{1}{σ \sqrt{2 π}} {e}^{- \frac{{( x - μ )}^{2}}{2 {σ}^{2}}} \qquad ( 1 )$$

For the purpose of the describing this feature, the content has been considered as an image, which may correspond to a frame of the multimedia content, an image of the document.

In an embodiment, the first Gaussian function may be defined along the width of the image and may correspond to a distribution of a first intermediate score along the width of the image. Further, the peak of the first Gaussian function may correspond to the center position in the image. Therefore, any word in the center of the image may have a high first intermediate score. In an embodiment, the second Gaussian function may be defined along the length of the image and may correspond to a distribution of a second intermediate score along the length of the image. Further, the peak of the second Gaussian function corresponds to a top most edge in the image. Therefore, any word that is at the top most edge of the image may have a high second intermediate score. A person having ordinary skills in the art will understand that the scope of the disclosure is not limited to defining the first Gaussian function and the second Gaussian function for the image. In an embodiment, when the content corresponds to the multimedia content, the first Gaussian function and the second Gaussian function may be defined for each frame in the multimedia content. In certain scenarios, the multimedia content may comprise a portion that comprises the plurality of words. For example, a whiteboard on which the presenter may have written text or the plurality of words. In such a scenario, the first Gaussian function and the second Gaussian function may be defined for the portion in the frame. Further, a person having ordinary skills in the art will understand that the scope of the disclosure is not limited to defining the first Gaussian function and the second Gaussian function such that they correspond to the center position and the top most edge in the image, respectively. In an embodiment, the first Gaussian function and the second Gaussian function may be defined to correspond to any position in the frame of the multimedia content.

In an embodiment, the image processing unit 206 may further be configured to determine a centroid of the bounding box associated with each of the plurality of words in the content. As discussed, in conjunction with step 302, the image processing unit 206 may define the bounding box for each of the plurality of content items in the content. Therefore, the image processing unit 206 may define the bounding box for each of the plurality of words.

Thereafter, the image processing unit 206 may determine the coordinates of the centroid of the bounding box. Further, the image processing unit 206 may determine the first intermediate score and the second intermediate score for the word based on the coordinates of the centroid, the first Gaussian function and the second Gaussian function. As discussed, the first Gaussian function and the second Gaussian function correspond to the distribution of the first intermediate score and the second intermediate score corresponding to the positions on the image or the content. Therefore, the first intermediate score and the second intermediate score corresponding to the coordinates of the centroid are determined from the first Gaussian function and the second Gaussian function.

In an embodiment, the image processing unit 206 may be configured to determine a position score for each of the plurality of words based on a cumulative score obtained from the first intermediate score and the second intermediate score associated with each of the plurality of words. In an embodiment, the position score may be indicative of the saliency of the word from the plurality of words. In an embodiment, the position score varies based on the distance of the word (i.e., distance of the centroid of the respective bounding box) from the center position, in the image, or position of the top most edge in the image. In an embodiment, the saliency of the word reduces, as the distance of the word from the center position, in the image, and the top most edge, in the image, increases.

### Aesthetic Features

In an embodiment, the image processing unit 206 may be configured to determine the one or more aesthetic features associated with each of the plurality of words. In an embodiment, as discussed supra, the one or more aesthetic features may comprise bolding of a word, the font size of the word, the font type of the word, the letter case of the word, the underlining of the word, and the color.

### Font Size of a Word

In an embodiment, the image processing unit 206 may determine the font size of each of the plurality of words in the content. In an embodiment, image processing unit 206 may determine a width to height ratio of the characters in the word to determine the font size. In an embodiment, the height and width of the character in the word may be determined based on the count of pixels representing the character. In an alternate embodiment, the font size of the word may be determined based on the length and width of the bounding box (determined in the step 302). In an embodiment, the image processing unit 206 may thereafter look up the determined width to height ratio of the character in a look up table to determine the font size of the character. In an embodiment, the look up table may comprise width to height ratio of the characters and corresponding font size. In an embodiment, if a word of the plurality of words has a font size greater than the other word in the plurality of words, then the word may have higher saliency than the other words in the content. For example, the image processing unit 206 determines the font size of the word “Newton's” to be 16 pt. Further, the image processing unit 206 determines the font size of the word “First” to be 12 pt. Therefore, the word “Newton's” may have higher saliency than the word “First”.

### Boldness of a Word

In an embodiment, the image processing unit 206 may determine a boldness of the word in the plurality of words. In an embodiment, if the word is presented in bold in the content, the word may be of importance as compared with the other words in the plurality of words. In an embodiment, to determine the boldness of the word, the image processing unit 206 may binarize the image. Thereafter, the image processing unit 206 may determine a number of pixels representing each of the plurality of words in the image. Thereafter, the image processing unit 206 may normalize the number of pixels representing each of the plurality of words with a number of characters present in the respective words, to determine the boldness feature value of each of the plurality of words. In an embodiment, the image processing unit 206 may further normalize the number of pixels based on the size of the bounding box encompassing the word.

### Underlining of a Word

In an embodiment, the image processing unit 206 may determine whether the word of the plurality of words is underlined, in the content. In an embodiment, the image processing unit 206 detects horizontal or near-horizontal line segments in the bounding box associated with the word. In an embodiment, the image processing unit 206 detects the horizontal or near-horizontal line segments in the word image using an image processing technique like, but not limited to, Hough transform. In an embodiment, the image processing unit 206 may determine the underlining feature value as a binary value (0 or 1) indicating whether an underlining with the word is present. In an embodiment, the underlined words may be of importance in comparison with non-underlined words.

### Letter Case of a Word

In an embodiment, the image processing unit 206 may determine a letter case of the character in the word. In an embodiment, the image processing unit 206 may determine the letter case of the characters in the word by determining ASCII equivalent of the characters in the word. For example, ASCII value of the character “A” is 65 and ASCII value of the character “a” is 97. In an embodiment, the image processing unit 206 may determine the capitalization feature value as a binary value (0 or 1) indicating whether the word is capitalized in the image. In an embodiment, the words with all characters in upper case may have more saliency than other words.

### Isolation of a Word

In an embodiment, the image processing unit 206 may determine an isolation feature value for the word in the plurality of words. The isolation feature value represents how isolated the word is in the content. In an embodiment, the isolation feature for the word in a line in the content may be determined based on a number of lines in the content, and a number of words in the line comprising the word under consideration. To determine the degree of isolation of the word in the content, the image processing unit 206 may determine the number of words in the line. In an embodiment, if the number of the words in the line is less than a predetermined threshold, the word is considered to be isolated. For example, the title of the content is “Newton's”. The image processing unit 206 may determine that there is no other word in the title line. Therefore, the word “Newton's” may be marked as isolated. In an embodiment, the image processing unit 206 may assign a binary value (0 or 1) indicating whether the word is isolated.

### Padding of a Word

In an embodiment, the image processing unit 206 may determine empty spaces available below and above the word. In an embodiment, more the empty spaces more is the saliency of the word. For example, after the title, the document may have some empty space before the next line is observed. Therefore, the word representing the title may have higher saliency than the other words in the plurality of words in the content. In an embodiment, the image processing unit 206 may determine a padding feature based on a number of empty pixels between the word and the next adjacent line (line spacing between the word and the next adjacent line). In an embodiment, the next adjacent line may correspond to line above and below the word.

A person having ordinary skills in the art will understand that the word under consideration may be present in a line in the content. Therefore, the image processing unit 206 may calculate the line spacing between the line and the next adjacent line to determine the padding feature.

In an embodiment, when the content corresponds to the multimedia content, the processor 202 may be further configured to determine one or more audio features associated with each of the plurality of words. In an embodiment, the processor 202 may extract audio segment, corresponding to each of the plurality of words, from the audio signal in the multimedia content. In an embodiment, for each audio segment, the processor 202 may determine a pitch, a sentiment, volume, tone, phonetic, user's accent information. For example, if the presenter has spoken certain words more loudly or with more audible stress. Such words with more audible stress may be important words than other words in the plurality of words.

A person having ordinary skills in the art will understand that the scope of the disclosure is not limited to determining the one or more features for the plurality of words. In an embodiment, the one or more features may be determined for any other identified content item in the content. Further, a person having ordinary skills in the art will understand that the scope of the disclosure is not limited to having the above mentioned features as the one or more features. In an embodiment, the one or more features may vary based on the type of the content items. For example, if the content item corresponds to the image content, the one or more features may include contrast ratio, color vibrancy, etc.

At step 308, a weight associated with each of the one or more features associated with the each of the plurality of content items is determined. In an embodiment, the training unit 208 may be configured to determine the weight. In an embodiment, the training unit 208 may crowdsource another content to the one or more worker computing devices associated with the one or more workers. In an embodiment, training unit 208 may create a task, based on the another content, asking the one or more workers to select one or more content items from the plurality of content items in the another content, which are salient to the content. Further, the one or more workers are asked to mention a feature associated with the one or more content items that caused them to select the one or more content items.

In an embodiment, the training unit 208 may receive the responses from the one or more workers. In an embodiment, the responses may include the one or more selected content items and the feature that caused the one or more workers to select them. Following table illustrates sample responses received from the one or more workers:

TABLE 1
Response received from the one or more workers

| One or more content items | Features |
|---|---|
| Newton's | Boldness, isolation |
| First | Boldness, underline |

Referring to Table 1, it can be observed that boldness feature associated with the content items was one of the reason behind selection of both the content items “Newton's” and “First”.

In an embodiment, the training unit 208 may determine the weights for each of the one or more features based on a number of times a feature of the one or more features caused the one or more workers to select a content item. For example, the training unit 208 may assign a higher weightage to the feature boldness than to the features isolated and underline.

In an alternate embodiment, the training unit 208 may train the one or more classifiers that are configured to assign weights to the one or more features associated with the one or more content items. As discussed supra, to train the one or more classifiers, the training unit 208 may crowdsource another multimedia content to the one or more workers. The one or more workers may select one or more content items from the another multimedia content. Thereafter, the training unit 208 may determine the one or more features associated with the one or more content items. Accordingly, the training unit 206 may assign weights to the selected one or more content items. Based on the weights assigned to the one or more content items in the another multimedia content, the training unit 208 may train the one or more classifiers.

At step 310, the score for each of the plurality of content items is determined. In an embodiment, the scoring unit 210 may be configured to determine the score. In an embodiment, the scoring unit 210 may receive the feature value of the one or more features associated with each of the plurality of content items from the image processing unit 206. Further, the scoring unit may receive the weight assigned to each of the one or more features from the training unit 208. Thereafter, the scoring unit 210 may utilize the following equation to determine the score for each of the plurality of content items:

S(w)=Σᵢ₌₁⁹W(i)*U(i) (2)

where,

S(w) is the determined score for a content item w, U is the determined feature value for the content item w,

W is the predetermined weight associated with the one or more features.

At step 312, the one or more content items are selected from the plurality of content items in the content. In an embodiment, the processor 202 may extract the one or more content items, as salient content items, from the plurality of content items based on the determined score. In an embodiment, the processor 202 may compare the determined score for each of the plurality of content items with a predetermined threshold score. In case, the determined score for the content item is equal or higher than the predetermined threshold score, then the processor 202 may mark that content item as a salient content item.

In an embodiment, the application server 102 may select the one or more content items for other content in the content repository server 104. In an embodiment, the identified one or more content items may be used to index the content in the content repository server 104. In another embodiment, the one or more content items identified for the content may be used to create the table of content for the content itself. In an embodiment, the created table of content may be used to navigate through the content. For example, the application server 102 may have identified the one or more content items in a multimedia content. Further, the application server 102 may have further stored the timestamp associated with the identified one or more content items. Thereafter, the application server 102 may be configured to create a table of content comprising the one or more content items and the corresponding timestamp. In an embodiment, when a user provides an input to select a content item from the one or more content items listed in the table of contents, the playback of the multimedia content may start from the timestamp associated with the selected content item. Then the control passes to the end step 314.

FIGS. 4A and 4B are a snapshot 400 of a multimedia content, in accordance with an embodiment. The snapshot 400 may correspond to a frame 402 of the multimedia content. In an embodiment, the frame 402 of the multimedia content comprises a presenter 404, and a predetermined area 406. In an embodiment, the predetermined area 406 may correspond to a whiteboard, a power point presentation and/or the like.

In an embodiment, the image processing unit 206 may identify a plurality of frames in the multimedia content. In an embodiment, for each of the plurality of frames, the image processing unit 206 may extract the predetermined area 406. In an embodiment, the predetermined area 406 may be extracted using one or more predetermined image processing techniques such as SIFT.

After extraction of the predetermined area 406, the image processing unit 206 may identify the plurality of content items in the predetermined area 406. To identify the plurality of content items, the image processing unit 206 may determine the horizontal projection profile 408 and the vertical projection profile 410 of the predetermined area 406. Referring to the horizontal projection profile 408, the peak 412 may represent a presence of the plurality of words. Further, the valley 414 represents the absence of the plurality of words. Similarly, in the vertical projection profile 410, the peak 416 corresponds to the presence of the plurality of words, and the valley 418 corresponds to the absence of the plurality of words.

In an embodiment, the image processing unit 206 may be configured to identify the plurality of words based on the peaks and the valleys of each of the horizontal projection profile 408 and the vertical projection profile 410. In an embodiment, image processing unit 206 may further define a bounding box around each of the plurality of words. For example, the bounding box 420a is defined around the word “Newton's”. In an embodiment, defining of the bounding box may correspond to segmenting a frame of the multimedia content into one or more regions.

In an embodiment, for each of the plurality of words, the image processing unit 206 may be configured to determine the frequency of occurrence of the word. For example, the number of occurrences of the word “Newton” is four, referring to FIG. 4B. In an embodiment, the image processing unit 206 may further define the first Gaussian function 422 and the second Gaussian function 424. In an embodiment, the first Gaussian function 422 is defined such that it corresponds to the center position 426 in the predetermined area 406. In an embodiment, the second Gaussian function 424 is defined such that it corresponds to the top most edge 428 in the predetermined area 406.

Thereafter, the image processing unit 206 may determine the centroid of the bounding box 420a around the word “Newton's”. Further, the image processing unit 206 may determine the position of the centroid. Thereafter, based on the first Gaussian function, and the second Gaussian function, the image processing unit 206 may determine the position score for the word “Newton” (as discussed in the step 304).

Further, the image processing unit 206 may determine the one or more aesthetic features associated with the plurality of words. For example, the image processing unit 206 may determine the font of the word “Newton's” based on the width “w” and height “h” of the bounding box 420a. For example, the font size of the word “Newton” is 12 pt. In an embodiment, the image processing unit 206 may determine the count of the pixels of the word “Newton”. In an embodiment, the image processing unit 206 may determine the boldness of the word “Newton's” based on the count of the pixels, width of the bounding box 420a, and height of the bounding box 420a. In an embodiment, the image processing unit 206 may determine binary value “1” for the word “Newton” as the word is presented in bold.

Further, the image processing unit 206 may determine whether the word “Newton's” is underlined. In an embodiment, the image processing unit 206 may determine the presence of the horizontal line in the bounding box 420a. In an embodiment, the image processing unit 206 may assign binary value “0”, as the word “Newton's” is not underlined.

In an embodiment, the image processing unit 206 may determine the isolation of the word “Newton's”. In an embodiment, the image processing unit 206 may determine the number of words in present in the line where the word “Newton's” has been written. For example, the line has three words. In an embodiment, the image processing unit 206 may determine the number of words in the line based on the horizontal projection profile 408 of the image. Further, based on the horizontal projection profile 408, the image processing unit 206 may determine the padding of the word “Newton's”. In an alternate embodiment, for the word “Newton's”, the image processing unit 206 may determine a count of empty pixels between the bounding box 420a and adjacent lines. For example, the word “Newton's” has a padding of two lines.

Thereafter, the scoring unit 210 may determine the score for the word “Newton's” based on the weights assigned to each of the one or more features and the corresponding feature values. In an embodiment, the score corresponds to the weighted sum of the feature values. Let the determined score be 4.5. Thereafter, the scoring unit 210 may compare the score with a threshold value. Let the threshold value be 2. When the determined score is greater than the threshold value, the word “Newton” is selected as the one or more words.

The disclosed embodiments encompass numerous advantages. In an embodiment, the extracted one or more contents items may be used to index the content in the content repository server. Further, the extracted one or more content items may be used to create a table of content for the content itself. Further, the created table of content may enable a user to navigate through the content. The table of content may contain a timestamp associated with the one or more content items. When a user provides input to select a content item from the table of content, the playback of the content may start from the timestamp corresponding to the selected content item. As the extracted one or more content items are salient, the extracted one or more content items may be utilized to summarize the content.

The disclosed methods and systems, as illustrated in the ongoing description or any of its components, may be embodied in the form of a computer system. Typical examples of a computer system include a general purpose computer, a programmed microprocessor, a micro-controller, a peripheral integrated circuit element, and other devices, or arrangements of devices that are capable of implementing the steps that constitute the method of the disclosure.

The computer system comprises a computer, an input device, a display unit, and the internet. The computer further comprises a microprocessor. The microprocessor is connected to a communication bus. The computer also includes a memory. The memory may be RAM or ROM. The computer system further comprises a storage device, which may be a HDD or a removable storage drive such as a floppy-disk drive, an optical-disk drive, and the like. The storage device may also be a means for loading computer programs or other instructions onto the computer system. The computer system also includes a communication unit. The communication unit allows the computer to connect to other databases and the internet through an input/output (I/O) interface, allowing the transfer as well as reception of data from other sources. The communication unit may include a modem, an Ethernet card, or similar devices that enable the computer system to connect to databases and networks such as LAN, MAN, WAN, and the internet. The computer system facilitates input from a user through input devices accessible to the system through the I/O interface.

To process input data, the computer system executes a set of instructions stored in one or more storage elements. The storage elements may also hold data or other information, as desired. The storage element may be in the form of an information source or a physical memory element present in the processing machine.

The programmable or computer-readable instructions may include various commands that instruct the processing machine to perform specific tasks such as steps that constitute the method of the disclosure. The systems and methods described can also be implemented using only software programming, only hardware, or a varying combination of the two techniques. The disclosure is independent of the programming language and the operating system used in the computers. The instructions for the disclosure can be written in all programming languages including, but not limited to, “C,” “C++,” “Visual C++,” and “Visual Basic”. Further, software may be in the form of a collection of separate programs, a program module containing a larger program, or a portion of a program module, as discussed in the ongoing description. The software may also include modular programming in the form of object-oriented programming. The processing of input data by the processing machine may be in response to user commands, the results of previous processing, or from a request made by another processing machine. The disclosure can also be implemented in various operating systems and platforms, including, but not limited to, “Unix,” “DOS,” “Android,” “Symbian,” and “Linux.”

The programmable instructions can be stored and transmitted on a computer-readable medium. The disclosure can also be embodied in a computer program product comprising a computer-readable medium, with any product capable of implementing the above methods and systems, or the numerous possible variations thereof.

Various embodiments of the methods and systems for extracting content items from content have been disclosed. However, it should be apparent to those skilled in the art that modifications, in addition to those described, are possible without departing from the inventive concepts herein. The embodiments, therefore, are not restrictive, except in the spirit of the disclosure. Moreover, in interpreting the disclosure, all terms should be understood in the broadest possible manner consistent with the context. In particular, the terms “comprises” and “comprising” should be interpreted as referring to elements, components, or steps, in a non-exclusive manner, indicating that the referenced elements, components, or steps may be present, used, or combined with other elements, components, or steps that are not expressly referenced.

A person with ordinary skills in the art will appreciate that the systems, modules, and sub-modules have been illustrated and explained to serve as examples and should not be considered limiting in any manner. It will be further appreciated that the variants of the above disclosed system elements, modules, and other features and functions, or alternatives thereof, may be combined to create other different systems or applications.

Those skilled in the art will appreciate that any of the aforementioned steps and/or system modules may be suitably replaced, reordered, or removed, and additional steps and/or system modules may be inserted, depending on the needs of a particular application. In addition, the systems of the aforementioned embodiments may be implemented using a wide variety of suitable processes and system modules, and are not limited to any particular computer hardware, software, middleware, firmware, microcode, and the like.

The claims can encompass embodiments for hardware and software, or a combination thereof.

It will be appreciated that variants of the above disclosed, and other features and functions or alternatives thereof, may be combined into many other different systems or applications. Presently unforeseen or unanticipated alternatives, modifications, variations, or improvements therein may be subsequently made by those skilled in the art that are also intended to be encompassed by the following claims.

What is claimed is:

1. A system for extracting one or more content items from content, said system comprising:
one or more processors configured to:
determine one or more features associated with each of a plurality of content items in said content, wherein the one or more features comprises at least a frequency of occurrence of said plurality of content items in said content;
determine a score for each of said plurality of content items based on a weight assigned to each of said one or more features associated with each of said plurality of content items, and a feature value associated with each of the one or more features; and
extract said one or more content items from said plurality of content items based on said determined score, wherein extracted said one or more content items are utilized to create at least an index of said content.

2. The system of claim 1, wherein said one or more features further comprises:
a position of said plurality of content items in said content, and
one or more aesthetic features associated with said plurality of content items, wherein said one or more aesthetic features comprises one or more of: a font size of a content item, a bolding of said content item, an underlining of said content item, a letter case associated with said content item.

3. The system of claim 2, wherein said one or more processors are configured to define a first Gaussian function and a second Gaussian function for the content, wherein said first Gaussian function is defined along a width of the content and corresponds to a distribution of a first intermediate score along the width of said content, and said second Gaussian function is defined along a length of the content and corresponds to a distribution of a second intermediate score along the length of the content.

4. The system of claim 3, wherein said one or more processors are configured to determine the first intermediate score and the second intermediate score for each of the plurality of content items based on a position of the said plurality of content items in the content, the first Gaussian function and the second Gaussian function, wherein a position score for each of the plurality of content items is determined based on the first intermediate score and the second intermediate score.

5. The system of claim 1, wherein said one or more processors are configured to assign said weight to each of said one or more features.

6. The system of claim 1, wherein said one or more processors are configured to train one or more classifiers based on one or more inputs, associated with another content, received from one or more worker computing devices, wherein said one or more inputs comprises said one or more features that caused said one or more workers to select one or more content items from said another content.

7. The system of claim 6, wherein said one or more processors are configured to:
determine said one or more features associated with said one or more content items selected from said another content, and
determine said weight based on said one or more features associated with said one or more content items selected from said another content.

8. The system of claim 1, wherein said one or more processors are configured to:
compare said score associated with each of said plurality of content items with a predetermined threshold, and
extract said one or more content items based on said comparison.

9. The system of claim 1, wherein said one or more content items are utilizable to summarize said content.

10. The system of claim 1, wherein said content corresponds to video content, wherein said one or more processors are configured to:
determine a plurality of frames in said video content; and
segment each of said plurality of frames into one or more regions,
wherein each of said segmented one or more regions include at least one of said plurality of content items.

11. The system of claim 10, wherein said one or more processors are configured to:
determine said one or more features associated with each of the plurality of content items, where said one or more features comprise a count of said plurality of content items in each of said plurality of frames; and
determine said score for each of said plurality of content items based on said count.

12. The system of claim 1, wherein said one or more features comprise an isolation feature, wherein said isolation feature for a content item in a line in said content is determined based on a number of lines in said content and a number of content items in said line.

13. The system of claim 12, wherein said one or more features further comprises a padding feature, wherein said padding feature of said content item in said line is based on a line spacing between said line and another lines adjacent to said line.

14. The system of claim 13, wherein said one or more processors are configured to calculate said line spacing based on a number of pixels present between said line and said another lines adjacent to said line.

15. A method for extracting one or more content items from content, said method comprising:
determining, by one or more processors, one or more features associated with each of a plurality of content items in said content, wherein the one or more features comprises at least a frequency of occurrence of said plurality of content items in said content, a position of said plurality of content items in said content, and a formatting associated with said plurality of content items, wherein said formatting comprises one or more of: a font size, bolding of said plurality of content items, an underlining of said plurality of content items, a letter case associated with said plurality of content items;
determining, by said one or more processors, a predetermined weight for each of said one or more features by one or more classifiers, wherein the one or more classifiers are trained based on one or more inputs, pertaining to selection of one or more content items from another content, received from one or more worker computing devices;
determining, by said one or more processors, a score for each of said plurality of content items based on the predetermined weight of each of said one or more features associated with each of said plurality of content items; and
extracting, by said one or more processors, said one or more content items from said plurality of content items based on said determined score, wherein extracted said one or more content items are utilized to create at least an index of said content.

16. The method of claim 15, further comprising defining, by said one or more processors, a first Gaussian function and a second Gaussian function for the content, wherein said first Gaussian function is defined along a width of the content and corresponds to a distribution of a first intermediate score along the width of said content, and said second Gaussian function is defined along a length of the content and corresponds to a distribution of a second intermediate score along the length of the content.

17. The method of claim 15, further comprising:
comparing, by said one or more processors, said score associated with each of said plurality of content items with a predetermined threshold, and
extracting, by said one or more processors, said one or more content items based on said comparison.

18. A non-transitory computer readable medium having stored thereon, a computer program having at least one code section executable by a computer, thereby causing the computer comprising one or more processors to perform steps comprising:
determining one or more features associated with each of a plurality of content items in content, wherein the one or more features comprises at least a frequency of occurrence of said plurality of content items in said content;
determining a score for each of said plurality of content items based on a predetermined weight assigned to each of said one or more features associated with each of said plurality of content items; and
extracting said one or more content items from said plurality of content items based on said determined score, wherein extracted said one or more content items are utilized to create at least an index of said content.
